(19) United States
(12) Patent Application Publication
(10) Pub. No.: US 2015/0354701 A1
(43) Pub. Date: Dec. 10, 2015

(54) VIBRATION FEEDBACK SYSTEM FOR DRIVER

(71) Applicant: Ameya Phatak, Morgan Hill, CA (US)

(72) Inventor: Ameya Phatak, Morgan Hill, CA (US)

(21) Appl. No.: 14/224,069

(22) Filed: Mar. 25, 2014

(51) Int. Cl. F16H 63/42

(52) U.S. Cl. CPC F16H 63/42

(57) ABSTRACT

Disclosed is a vibrating notification device for an automobile. A vibrator is placed within touch of an automobile driver which vibrates upon the automobile engine speed reaching the proper shift point for the automobile. Additional embodiments include sequential lights which activate in order as the automobile's engine approaches the shift point speed.

### FIELD OF THE INVENTION

The present invention related to the field of automotive notifications. More particularly, the present invention relates to a vibrating driver notification for check engine light, shift points and other useful information.

### BACKGROUND OF THE INVENTION

Majority of present day automobiles, light and heavy trucks and tractors are equipped with multiple-speed transmissions and generally a few pedals. Manual transmissions require frequent shifting by the operator while all automatic transmissions have a manual-mode which requires the operator to actuate a mechanical or an automatic lever or paddles to command a gear change.

Prior art notifications include shift indicators which are often embodied by a single light on automobile dashboards. These shift light indicators require the vehicle operator to remove attention from the road. Other auditory notifications would interfere with cabin music playing and constitute a nuisance.

Tactile or vibration notification avoids these issues. Previously, invented by Zac Nelson of Ford in the OpenXC project, is a vibrating shift knob which requires the use of the OpenXC information platform and an Android operated device to function. Further the OpenXC shifter is configured to function on only a true manual. Accordingly, there is a need to create a shift notification which does not require the use of an Android device and is functional on a semi-automatic transmission (SAT).

### SUMMARY OF THE PRESENT INVENTION

It is an object of the present invention to provide a vibration notification to a vehicle without using an Android device.

A first aspect of the present invention teaches, An automobile notification device comprising: a vibrator, the vibrator located in the cabin of an automobile and in proximity to a driver station; circuitry, the circuitry wired to the vibrator such that the circuitry is capable of providing activation signals and power to the vibrator; and an engine computer, the engine computer configured to create signals which provide information regarding automobile engine status, wherein the engine computer is wired to the circuitry.

It is an additional object of the present invention to provide a shift notification on a semi-automatic transmission.

A second aspect of the present invention teaches the use the automatic transmission to provide engine speed shift data to then provide a vibration notification on the associated shift paddles to notify a driver to shift gears.

### BRIEF DESCRIPTION OF THE DRAWINGS

FIG. 1 is a front view of two shift paddles with a concealed vibration motor in each.

FIG. 2 is a front view of an up-shift paddle with concealed circuitry.

FIG. 3 is a front view of a down-shift paddle with concealed circuitry.

FIG. 4 is a side view a standard shift-knob and boot.

FIG. 5 is a shift-knob with a concealed vibration motor.

FIG. 6 is a shift-linkage with an integrated collar holding the vibrating motor concealed under the shift-boot.

FIG. 7 is a description of an iteration of the concealed circuitry of FIGS. 2 and 3.

### DETAILED DESCRIPTION

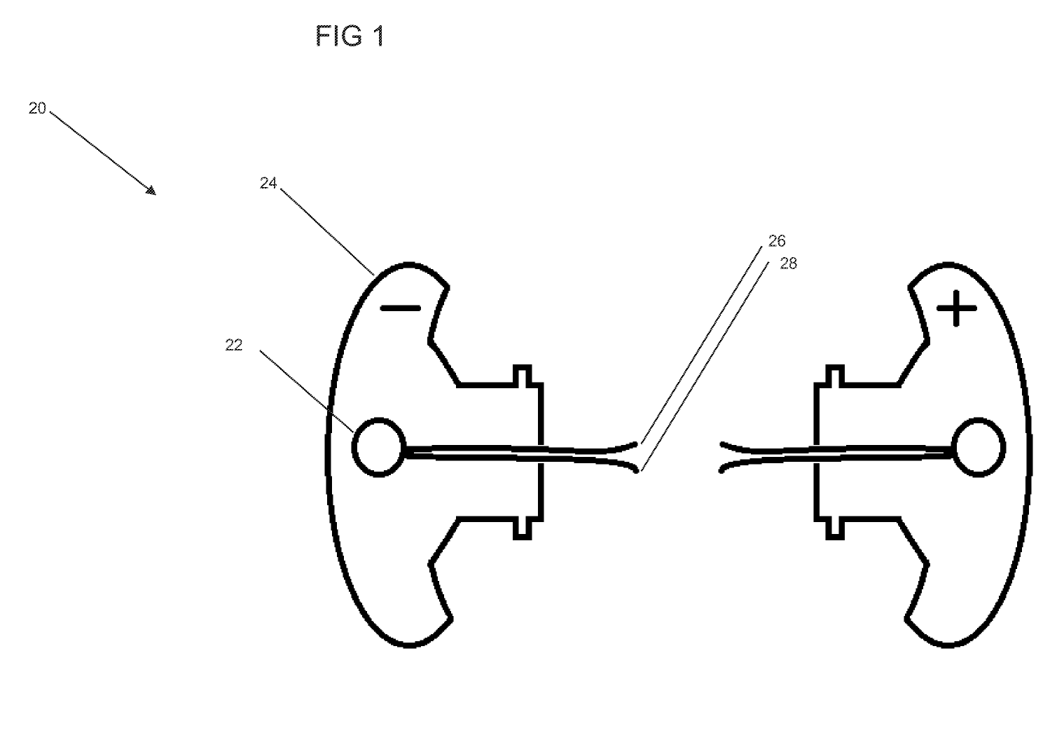

Referring now to FIG. 1, FIG. 1 is a portrayal of a first embodiment 20 of the present invention using paddle shifters. Paddle shifters are commonly used invention in relation to electronically controlled transmissions, also referred to as semi-automatic transmissions. These transmissions have a “manual mode” which the operator may select. in this mode, the operator is required to request gear changes. The first embodiment 20 includes a vibrator 22 placed behind each paddle shifter 24. The vibrator 22 is activated via two electric lines—ground 26, and activation 28. The activation line 28 receives a signal from an existing on board computer connected to the automatic transmission upon exceeding an engine speed above which the driver should shift gears. Upon receiving an activation signal, the vibrator 22 will buzz in both paddles notifying the driver to shift.

Alternatively, raw engine data may be obtained and a shift point calculation may be conducted externally by means of a micro-controller.

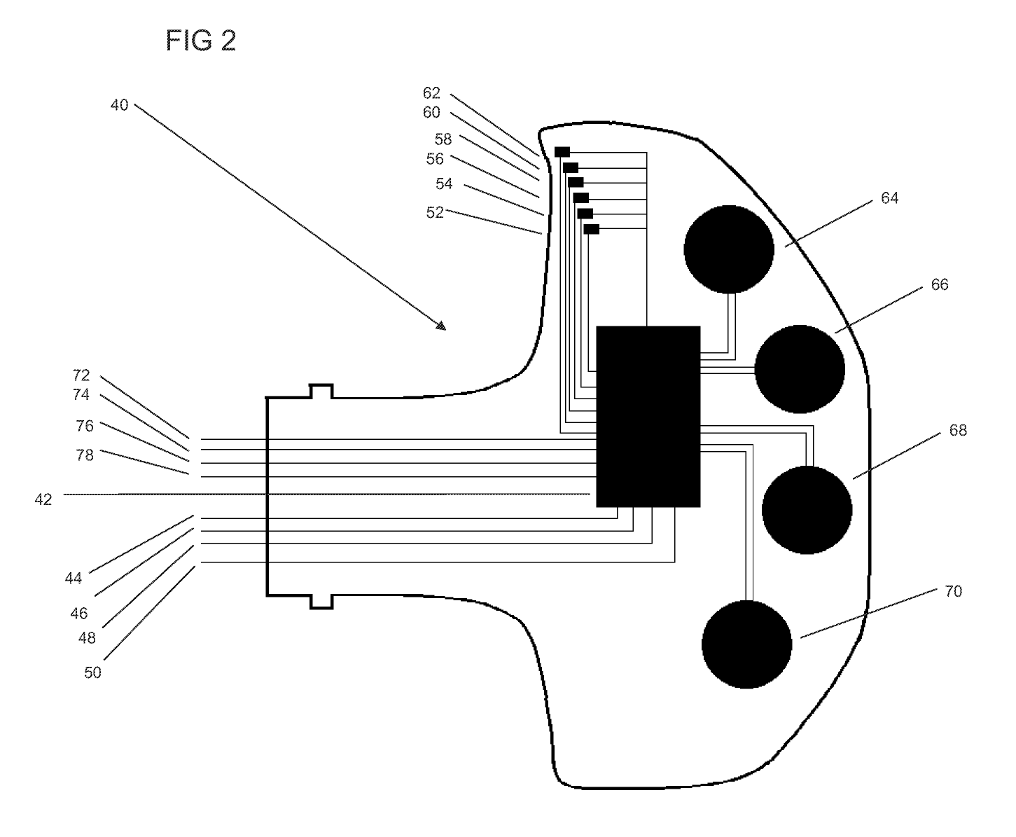

Referring now to FIG. 2, FIG. 2 displays second embodiment of the present invention with an up-shift paddle 40 concealing some circuitry. The micro-controller board 42 is connected by power 44, ground 46 and obtains engine speed by means of any standard communication method commonly available on production cars using 2 wires—BUS Receive 48 and BUS Send 50. The micro-controller board 42 constantly monitors engine speed and sequentially activates SMD LEDs 52, 54, 56, 58, 60 and 62 mounted on the surface of the paddle facing the driver leading up to the engine speed shift point where LED 62 is activated at the shift point simultaneously with vibrators 64, 66, 68 and 70. Additionally, the micro-controller board 42 sends the engine speed signal to another micro-controller mounted in the down-shift paddle using 4 connections—power 72, ground 74, serial send 76 and serial receive 78.

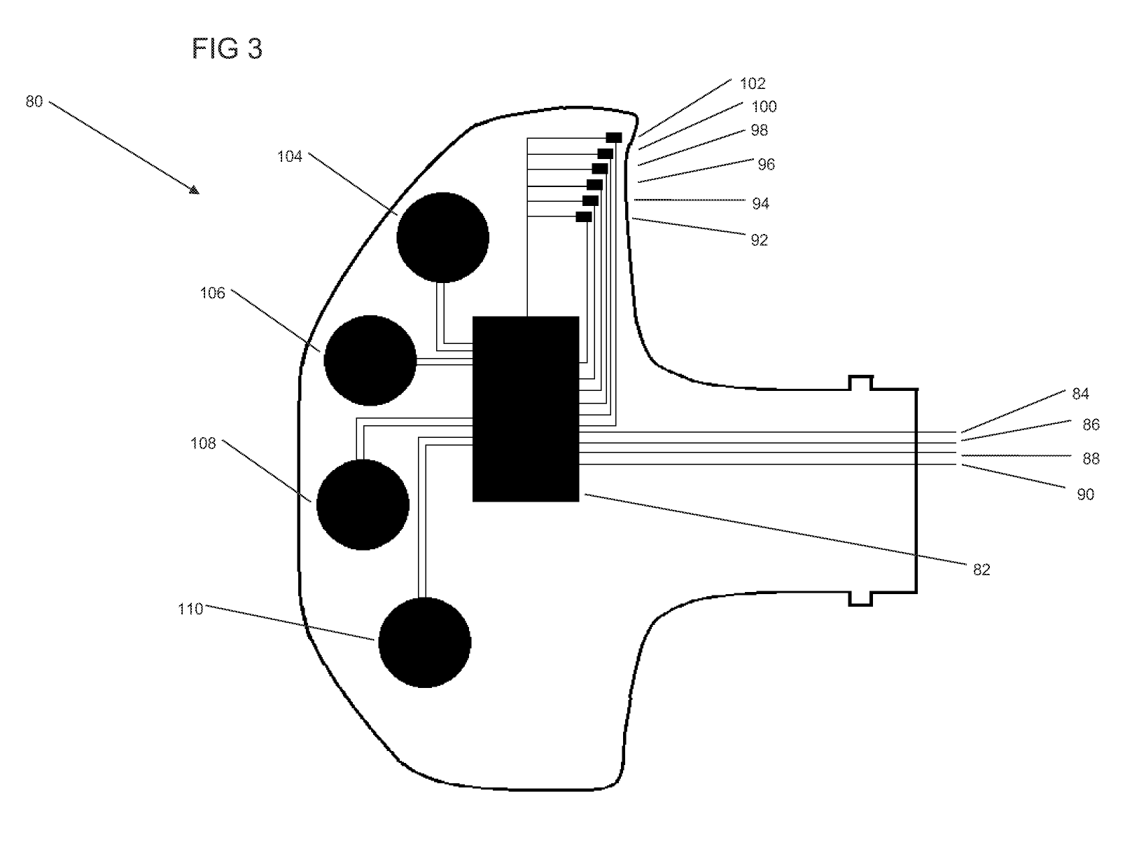

Referring now to FIG. 3, shows the down-shift paddle 80 associated with the up-shift paddle 40. This paddle is also embedded with a similar micro-controller board 82 which receives an engine speed signal from the adjacent micro-controller board 42 using 4 lines, power 84, ground 86, serial receive 88 and serial send 90. The micro-controller board 82, then activates SMD LEDs 92, 94, 96, 98, 100 and 102 and vibrators 104, 106, 108 and 110 in an identical pattern to the up-shift paddle. The calculation for the downshift signal will be conducted internally inside the micro-controller board 42. The down-shift signal will be generated upon decreasing engine speed until the engine speed is above a set speed. A down-shift signal may also be generated upon an increasing engine speed if the engine speed is below a set speed determined by the semi-automatic transmission. A downshift signal would vibrate at a different frequency than an up-shift signal and the LED's 92-102 and 52-62 would activate in reverse order.

The ability to read information over a communication bus enables the LEDs and the vibrators to activate upon other crucial events. In case of an existing fault within the OBD (on-board diagnostics), both paddles may vibrate simultaneously for a set period at a differing frequency than for shift notifications.

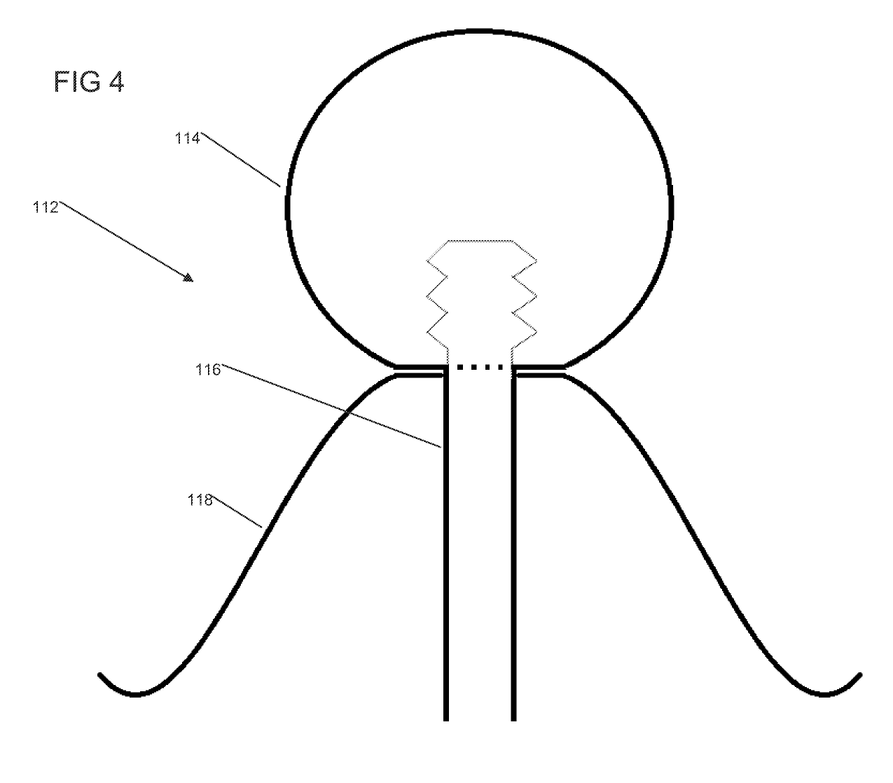

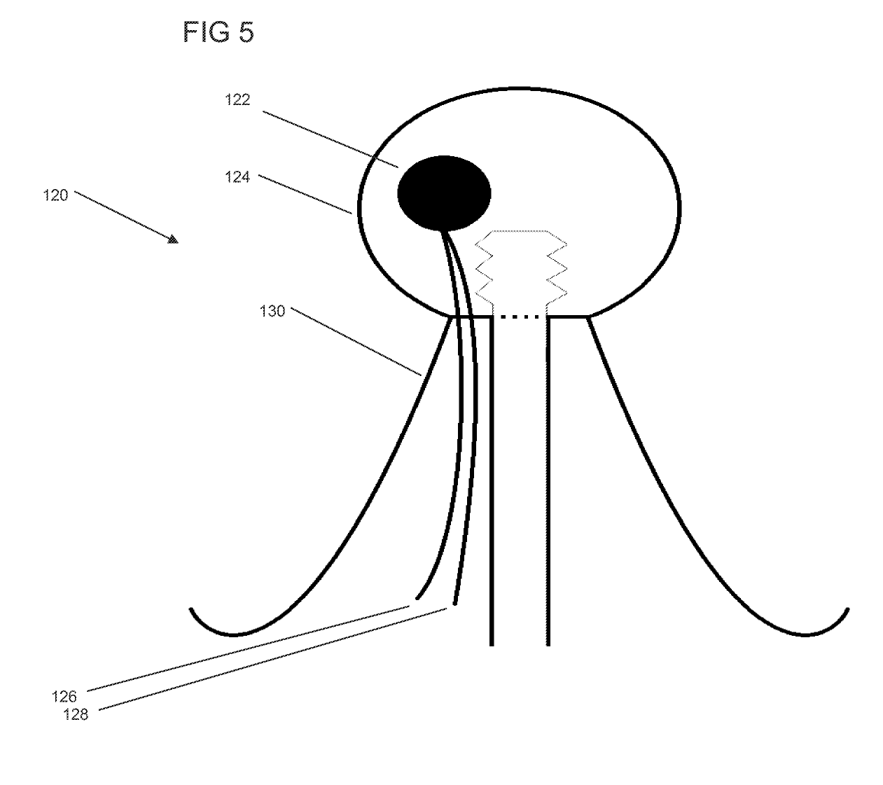

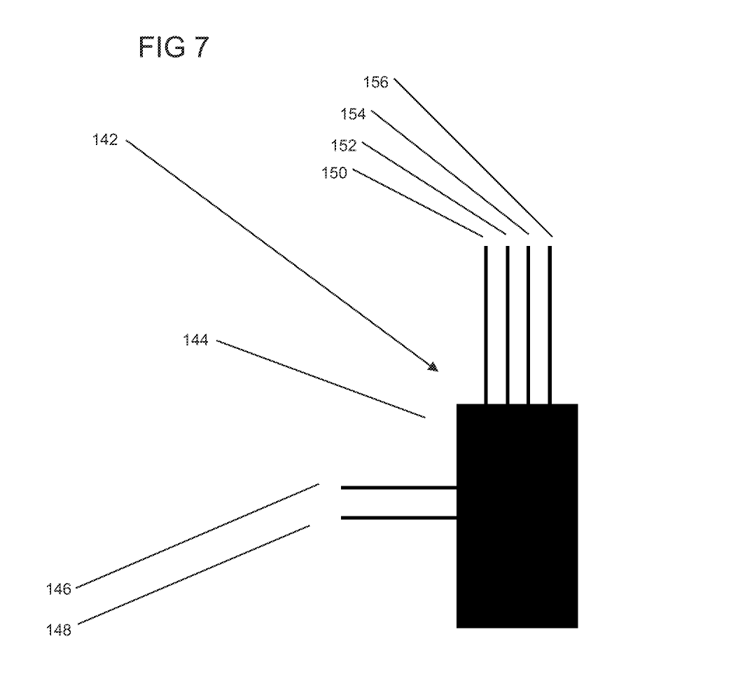

Referring now to FIGS. 4 and 5, FIG. 4 is a cross-section of a simple shifter assembly 112 consisting of a shift-knob 114, shift-linkage 116 and a shift-boot 118. The simple shifter 112 is a part of manual transmission. Such a transmission has no electrical components and requires the operator to do all the shifting and clutching. Referring now to FIG. 5, FIG. 5 shows a third embodiment of the present invention including a similar cross-section assembly 120, concealing a vibrating motor 122 inside the shift-knob 124. The vibrating motor 122 is activated via two electric lines—ground 126, and activation 128. The activation line 128 receives its signal at an engine speed above which the driver should shift gears—this shift signal must come from an existing output on the equipped engine controller. In the absence of such an output from the existing on board computers, an external device must be used to obtain a shift signal. Using a micro-controller (see FIG. 7) which is tapped into the OBD bus the microcontroller would be aware of the engine speed via the OBD bus and use a pre-programmed shift point in which to direct an activation signal to the vibrator 122. Upon receiving an activation signal, the vibrator 122 buzzes notifying the driver to shift. All circuitry is concealed under the shift-boot 130.

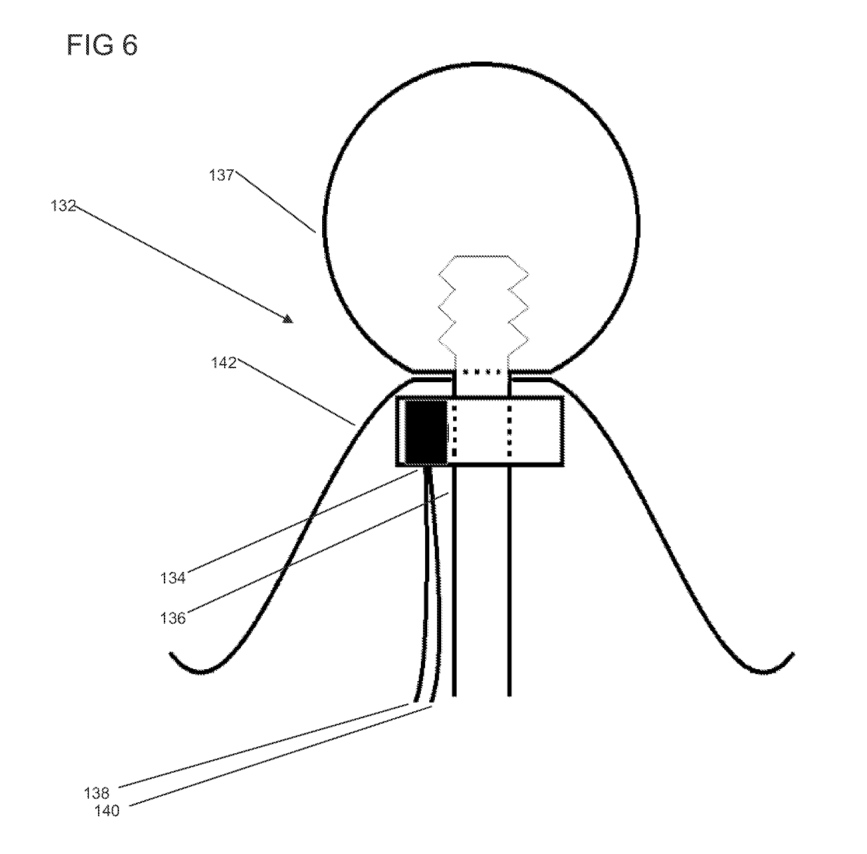

Referring now to FIG. 6, FIG. 6 is a fourth embodiment of the current invention a cross-section of the entire assembly 132. In this case, a vibrating motor 134 is integrated into the shift-linkage 136. This allows for a more compact ergonomic shift-knob 137. The vibrating motor 134 is activated via two electric lines—ground 138, and activation 140. The activation line 140 receives its signal from an existing on board computer upon exceeding an engine speed above which the driver should shift gears. Upon receiving an activation signal, the vibrator 134 notifying the driver to shift. All circuitry is concealed under the shift-boot 142.

Referring now to FIG. 7, FIG. 7 describes a micro-controller 142 would be placed within a car and that reads commonly available parameters over the OBD bus present on all vehicles. This micro-controller 142 would be used in the cases of a true manual transmission which would not be connected to any extra electronics as a semi-automatic transmission would. This device consists of a micro-controller board 144 which activates the vibrator via two lines, signal 146 and ground 148 which connect to the vibrating motor (126, 128). The micro-controller board 144 communicates with the vehicle via 4 lines—power 150, ground 152, serial send 154 and serial receive 156.

I claim:

1. An automobile notification device comprising:
a. a vibrator, the vibrator located in the cabin of an automobile and in proximity to a driver station;
b. circuitry, the circuitry wired to the vibrator such that the circuitry is capable of providing activation signals and power to the vibrator; and
c. an engine computer, the engine computer configured to create signals which provide information regarding automobile engine status, wherein the engine computer is wired to the circuitry.

2. The device of claim 1 wherein the vibrator is located inside a gear shift knob.

3. The device of claim 1 wherein the vibrator is affixed to a gear shift shaft.

4. The device of claim 1 wherein the vibrator is affixed to a paddle shifter.

5. The device of claim 4 wherein the engine computer is configured to send rotations per minute (RPM) signals indicating information concerning the RPM of the engine to the circuitry.

6. The device of claim 5 whereby the circuitry additionally communicates with an semi-automatic transmission including a manual mode (SAT), wherein the circuitry is configured to acquire an engine speed shift point from the SAT.

7. The device of claim 6 further comprising at least two sequential light emitting diodes (LEDs), the LEDs visible to a driver and configured to activate sequentially as RPM of the engine approaches the shift point provided by the SAT.

8. The device of claim 1 wherein the circuitry is configured to receive a RPM signal from the engine computer, the RPM signal indicating the current RPM of the engine; and the circuitry further configured to create an activation signal activating the vibrator at a first frequency upon the engine reaching a first pre-determined RPM.

9. The device of claim 1 wherein the circuitry further configured to create an activation signal activating the vibrator at a second frequency upon the engine slowing down to a second pre-determined RPM.

10. The method of providing vibration notification to a driver of an automobile comprising:
a. Operating an automobile with an automatic transmission with a manual mode, in the manual mode;
b. receiving in a micro controller an engine speed shift point;
c. sequentially activating lights on a shift paddle as an automobile engine approaches the speed indicated by the shift point;
d. activating a shift paddle mounted vibrator and a last shift paddle mounted light when the automobile engine speed reaches the indicated shift point.

11. The method of claim 10 further comprising
e. receiving in a microcontroller a notification of an on board diagnostic failure; and
f. activating a shift paddle mounted vibrator at a different frequency than in step “d.”
